(19) United States
(12) Patent Application Publication
(10) Pub. No.: US 2004/0053526 A1
(43) Pub. Date: Mar. 18, 2004

(54) Receive diversity antenna system for use with multiple radios

(76) Inventor: Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/447,405

(22) Filed: May 29, 2003

Related U.S. Application Data
(60) Provisional application No. 60/411,741, filed on Sep. 18, 2002.

(51) Int. Cl. H01R 29/00

(52) U.S. Cl. 439/188

(57) ABSTRACT

A technique is disclosed in which two radios share two antennas in a receive diversity antenna system without the costs associated with a low-noise amplifier. In particular, the illustrative embodiment uses a switching matrix (e.g., a double-pole, double-throw, single-break switch, etc.) to feed the stronger signal from the two antennas to one radio and the weaker signal from the two antennas to the second radio. Although this causes the second radio to always receive a weaker signal than the first radio, embodiments of the present invention are acceptable when the second of the two radios is capable of receiving weaker signals than is the first radio.

### CROSS-REFERENCE TO RELATED APPLICATIONS

The present invention claims the benefit of U.S. Provisional Patent Application Serial No. 60/411741, entitled “Mechanism For Sharing A Diversity Antenna System Between Colocated 802.11 And Bluetooth Radios,” filed on Sep. 18, 2002, which application is also incorporated by reference.

### FIELD OF THE INVENTION

The present invention relates to telecommunications in general, and, more particularly, to a receive diversity antenna system for use with multiple radios.

### BACKGROUND OF THE INVENTION

Before the 1980's, most computer users shared the resources of a single mainframe computer, and the centralized nature of the mainframe enabled those users to easily share information with each other. In the 1980's, increasing numbers of computer users used a personal computer, and the distributed nature of the personal computers hindered the users from sharing information with each other.

In fact, the most common way of transporting information from one personal computer to another in the early 1980's was by physically carrying a floppy disk from one machine to another. This was widely-known as, and facetiously called, a “sneaker net.”

To facilitate the sharing of information among personal computers, local area networks were born. The first local area networks had metal wires that directly connected the computers, but in the 1990's, local area networks that used radios, instead of wires, became popular.

FIG. 1 depicts a block diagram of the salient components of a network interface in the prior art for a host computer that is a member of two different local area networks—an 802.11 network and a Bluetooth network. Network interface 100 comprises: antenna 101-1, antenna 101-2, antenna 101-3, single-pole, double-throw, single-break switch 102, receive diversity controller 104, IEEE 802.11-compliant radio 105-1, and Bluetooth-compliant radio 105-2.

When a computer is part of a wireless local area network, the computer uses an antenna and radio to communicate with the other computers. Some radios, for example radio 105-2, only use one antenna, antenna 101-3. In contrast, some radios, for example radio 105-1 uses two antennas, antenna 101-1 and antenna 101-2. For a variety of reasons (e.g., to address Rayleigh fading, etc.), the ability of a radio to receive signals from other computers is usually improved when the radio uses two or more antennas rather than just one.

For example, the signals from antenna 101-1 and 101-2 are fed to receive diversity controller 104, which based on a receive diversity algorithm, causes the stronger of the signals on antennas 101-1 and 102-1 to be fed to radio 105-1.

The fact that radios 105-1 and 105-2 don't share antennas causes the cost of network interface 100 to rise, and, therefore, FIG. 2 depicts a block of the salient components of a network interface in which two radios do share antennas. In this arrangement, network interface 200 comprises: antenna 201-1, antenna 201-2, electrical connection mechanism 202, IEEE 802.11-compliant radio 203-1, and Bluetooth-compliant radio 203-2. The electrical connection mechanism 202 monitors the strength of the signals on antenna 201-1 and 201-2, and based on a receive diversity algorithm, feeds the stronger signal to radio 203-1 and radio 203-2.

FIG. 3 depicts a block diagram of the salient components of electrical connection mechanism 202 in the prior art. Electrical connection mechanism 202 comprises single-pole, double-throw, single-break switch 302, receive diversity controller 304, and low noise amplifier 305. As in FIG. 1, receive diversity controller 304 measures the strength of the signals on antenna 101-1 and 101-2 based on a receive diversity algorithm and causes switch 302 to feed the stronger signal to low noise amplifier 305 and then to both radios. Low noise amplifier is needed to boost the split signals going to both radios. Were it not for low noise amplifier 305, each radio would receive only one-half of the signal from the stronger antenna, and this might prevent either or both of the radios from receiving an adequate signal. The cost of low noise amplifier is prohibitively expensive in some network interfaces, and, therefore the need exists for an improved network interface.

### SUMMARY OF THE INVENTION

The present invention enables two or more radios to share two or more antennas in a receive diversity antenna system without some of the costs associated with the prior art. In particular, the illustrative embodiment eliminates the need for a low-noise amplifier.

The illustrative embodiment uses a switching matrix (e.g., a double-pole, double-throw, single-break switch, etc.) to feed the stronger signal from the two antennas to one radio and the weaker signal from the two antennas to the second radio. Although this causes the second radio to always receive a weaker signal than the first radio, embodiments of the present invention are acceptable when the second of the two radios is capable of receiving weaker signals than is the first radio.

The illustrative embodiment comprises: a switching matrix comprising a first antenna terminal, a second antenna terminal, a first radio terminal, a second radio terminal, and a control terminal; and a receive diversity controller comprising an output terminal that is electrically connected to the control terminal; wherein the receive diversity controller causes the switching matrix to: (i) electrically connect the first antenna terminal to the first radio terminal, and (ii) electrically connect the second antenna terminal to the second radio terminal when the quality of a first signal on the first antenna terminal is stronger than the quality of a second signal on the second antenna terminal; and wherein the receive diversity controller causes the switching matrix to: (i) electrically connect the first antenna terminal to the second radio terminal, and (ii) electrically connect the second antenna terminal to the first radio terminal when the quality of the first signal is weaker than the quality of the second signal.

### BRIEF DESCRIPTION OF THE DRAWINGS

FIG. 1 depicts a block diagram of the salient components of a network interface in the prior art for a host computer that is a member of two different local area networks.

FIG. 2 depicts a block of the salient components of a network interface in which two radios do share antennas.

FIG. 3 depicts a block diagram of the salient components of electrical connection mechanism 202 in the prior art.

FIG. 4 depicts a block diagram of the salient components of the illustrative embodiment of the present invention.

FIG. 5 depicts a block diagram of the salient components of switching matrix 401 in accordance with illustrative embodiment of the present invention.

FIG. 6 depicts a schematic the double-pole double-pole single-break switch when it is configured to connect one configuration of antennas to radios.

FIG. 7 depicts a schematic the double-pole double-pole single-break switch when it is configured to connect a second configuration of antennas to radios.

FIG. 8 depicts a flow diagram of the salient tasks performed in accordance with the illustrative embodiment of the present invention.

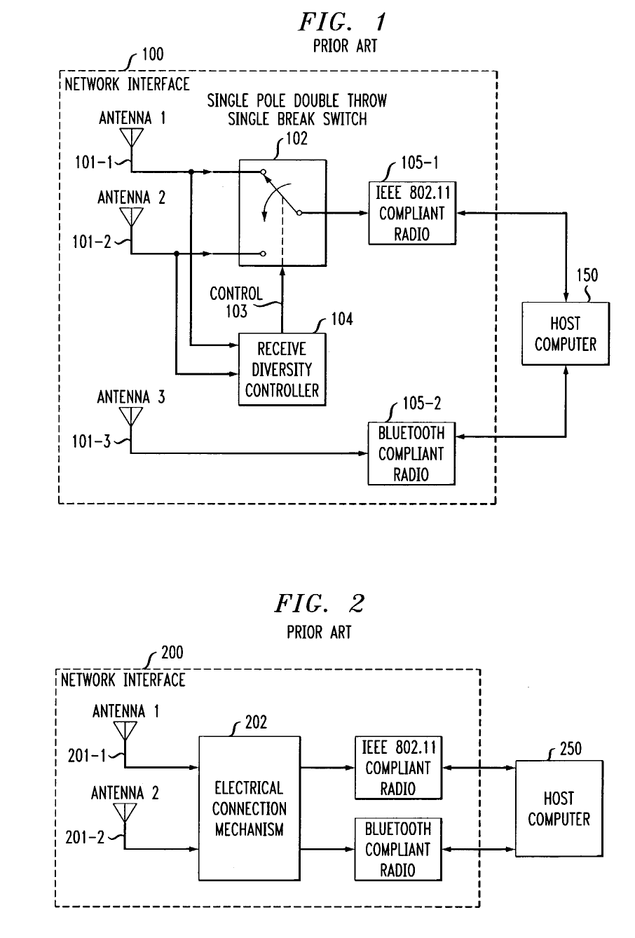

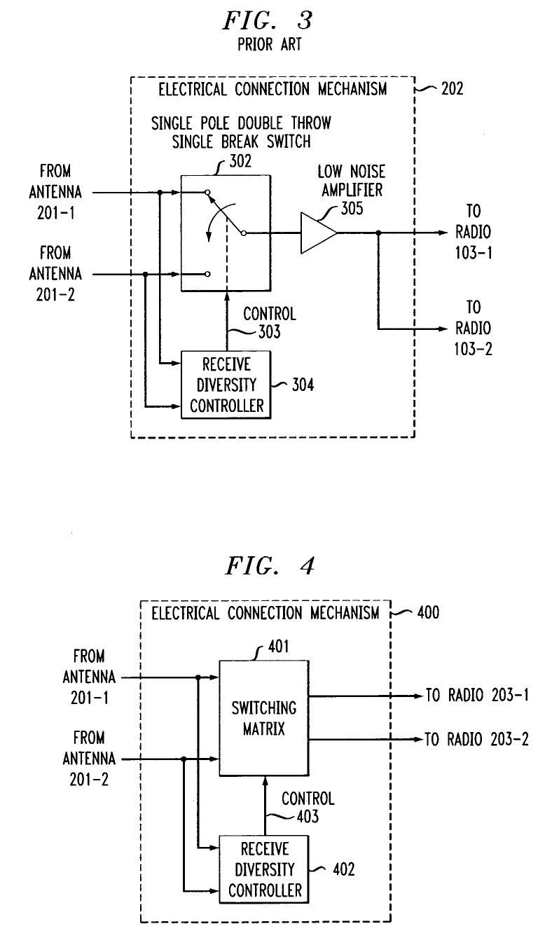

### DETAILED DESCRIPTION

FIG. 4 depicts a block diagram of the salient components of the illustrative embodiment of the present invention. Electrical connection mechanism 400 comprises: switching matrix 401 and receive diversity controller 402, interconnected as shown.

Switching matrix 401 selectively connects the incoming signals from antennas 201-1 and 201-2 to radios 203-1 and 203-2 under the control of receive diversity controller 402. The details of switching matrix 401 are described below and with respect to FIGS. 5, 6, and 7.

Receive diversity controller 402 receives signals from antennas 201-1 and 201-2. The strength of the signal on each antenna is determined by receive diversity controller 402 in accordance with a receive diversity algorithm optimized for IEEE 802.11 operation. Receive diversity controller 402 causes, via control signal 403, switching matrix 401 to feed the stronger of the signals on antenna 201-1 and antenna 201-2 to radio 203-1. Furthermore, receive diversity controller 402 causes, via control signal 403, switching matrix 401 to feed the weaker of the signals on antenna 201-1 and antenna 201-2 to radio 203-2.

FIG. 5 depicts a block diagram of the salient components of switching matrix 401 in accordance with illustrative embodiment of the present invention. Switching matrix 401 comprises double-pole, double-throw, single-break switch 501. Double-pole, double-throw, single-break switch 501 receives signals from antennas 201-1 and 201-2 and feeds those signals to radios 203-1 and 203-2 under the control of receive diversity controller 402.

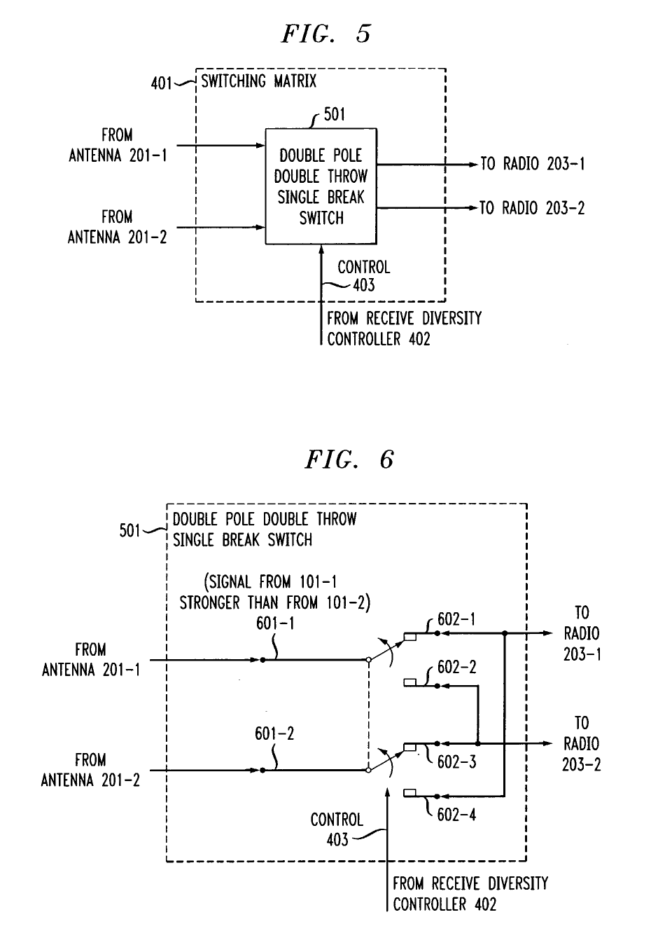

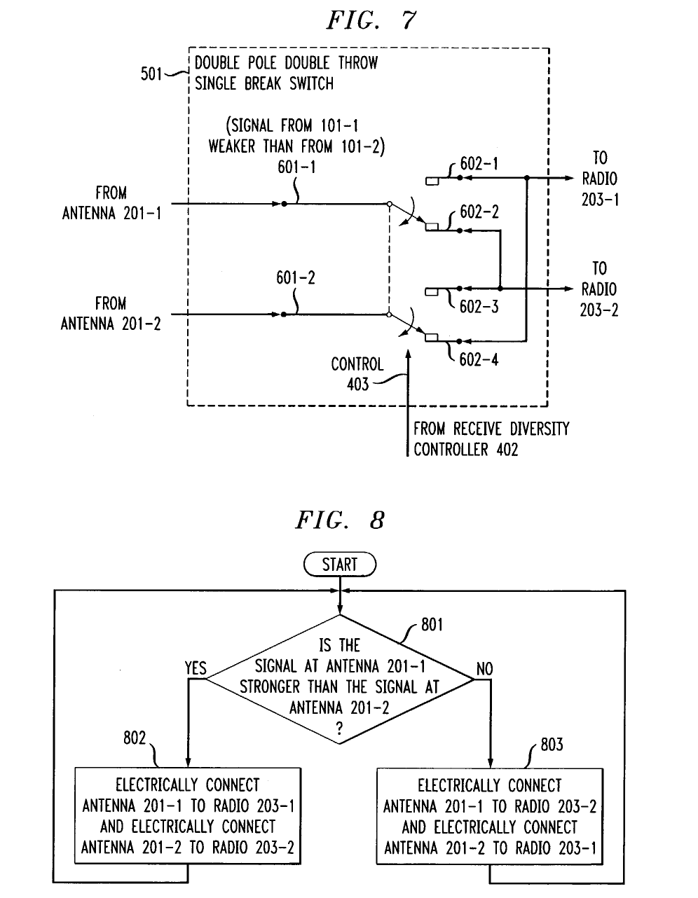

As is well-known to those skilled in the art, a double-pole, double-throw, single-break switch has two states. In the first state, which is depicted in FIG. 6, the signal from antenna 201-1 is fed to radio 203-1 via contacts 601-1 and 602-1, and the signal from antenna 201-2 is fed to radio 203-2 via contacts 601-2 and 602-3. In the second state, which is depicted in FIG. 7, the signal from antenna 201-1 is fed to radio 203-2 via contacts 601-1 and 602-2, and the signal from antenna 201-2 is fed to radio 203-1 via contacts 601-2 and 602-4.

FIG. 8 depicts a flow diagram of the salient tasks performed in accordance with the illustrative embodiment of the present invention.

At task 801, the illustrative embodiment determines whether the first signal at the first antenna is stronger than the second signal at the second antenna or not. When the first signal at the first antenna is stronger than the second signal at the second antenna, control passes to task 802.

At task 802, switching matrix 401 electrical connects a first antenna terminal to a first radio terminal and electrically connects the second antenna terminal to the second radio terminal. From task 802, control passes to task 801.

Back at task 801, when the first signal at the first antenna is weaker than the second signal at the second antenna, control passes to task 803.

At task 803, switching matrix 401 electrical connects the second antenna terminal to the first radio terminal and electrically connects the first antenna terminal to the second radio terminal. From task 803, control passes to task 801.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. An apparatus comprising:
a switching matrix comprising a first antenna terminal, a second antenna terminal, a first radio terminal, a second radio terminal, and a control terminal; and
a receive diversity controller comprising an output terminal that is electrically connected to said control terminal;
wherein said receive diversity controller causes said switching matrix to:
(i) electrically connect said first antenna terminal to said first radio terminal, and
(ii) electrically connect said second antenna terminal to said second radio terminal when the quality of a first signal on said first antenna terminal is stronger than the quality of a second signal on said second antenna terminal; and
wherein said receive diversity controller causes said switching matrix to:
(i) electrically connect said first antenna terminal to said second radio terminal, and
(ii) electrically connect said second antenna terminal to said first radio terminal when the quality of said first signal is weaker than the quality of said second signal.

2. The apparatus of claim 1 further comprising:
a first antenna that is electrically connected to said first antenna terminal; and
a second antenna that is electrically connected to said second antenna terminal.

3. The apparatus of claim 1 further comprising:
a first radio that is electrically connected to said first radio terminal; and
a second radio that is electrically connected to said second radio terminal.

4. The apparatus of claim 3 wherein said first radio is compliant with a different physical layer protocol than is said second radio.

5. The apparatus of claim 3 wherein said first radio is compliant with IEEE 802.11 and said second radio is compliant with Bluetooth.

6. The apparatus of claim 1 wherein said quality of said first signal and the quality of said second signal is considered best for IEEE 802.11 operation based on IEEE 802.11 receive diversity antenna control.

7. An apparatus comprising:
a first radio;
a second radio;
a first antenna for receiving a first signal;
a second antenna for receiving a second signal;
a receive diversity controller that feeds the stronger signal of said first signal and said second signal to said first radio and that feeds the weaker signal of said first signal and said second signal to said second radio.

8. The apparatus of claim 7 wherein said first radio is compliant with a first standard and wherein said second radio is compliant with a second standard that is different than said first standard.

9. The apparatus of claim 7 wherein said first radio is IEEE 802.11 compliant and said second radio is Bluetooth compliant.

10. The apparatus of claim 7 wherein said stronger signal is considered best for IEEE 802.11 operation based on IEEE 802.11 receive diversity antenna control.

11. An apparatus comprising:
a double-pole, double-throw, single-break switch, having a first input terminal, a second input terminal, a first output terminal, a second output terminal, a third output terminal electrically connected to said second output terminal, a fourth output terminal electrically connected to said first output terminal, and a control terminal;
a first antenna for receiving a first signal wherein said first antenna is electrically connected to said first input terminal of said switch;
a second antenna for receiving a second signal wherein said second antenna is electrically connected to said second input terminal;
a first radio that is compliant with a first protocol, wherein said first radio is electrically connected to said first output terminal of said switch;
a second radio that is compliant with a second protocol that is different than said first protocol, wherein said second radio is electrically connected to said second output terminal of said switch; and
a receive diversity controller comprising an output terminal that is electrically connected to said control terminal of said switch;
wherein said receive diversity controller causes said switching switch to:
(i) electrically connect said first input terminal to said first output terminal, and
(ii) electrically connect said second input terminal to said third output terminal when the quality of said first signal on said first antenna is stronger than the quality of said second signal on said second antenna; and
wherein said receive diversity controller causes said switch to:
(i) electrically connect said first input terminal to said second output terminal, and
(ii) electrically connect said second input terminal to said fourth output terminal when the quality of said first signal on said first antenna is weaker than the quality of said second signal on said second antenna.

12. The apparatus of claim 11 wherein said first radio is IEEE 802.11 compliant and said second radio is Bluetooth compliant.

13. The apparatus of claim 11 wherein said quality of said first signal and said quality of said second signal is considered best for IEEE 802.11 operation based on IEEE 802.11 receive diversity antenna control.

14. A method comprising:
electrically connecting a first antenna terminal to a first radio terminal and electrically connecting a second antenna terminal to a second radio terminal when the quality of a first signal on said first antenna terminal is stronger than the quality of a second signal on said second antenna terminal; and
electrically connecting said first antenna terminal to said second radio terminal and electrically connecting said second antenna terminal to said first radio terminal when the quality of said first signal on said first antenna terminal is weaker than the quality of said second signal on said second antenna terminal.

15. The method of claim 14 wherein said first radio is compliant with a different physical layer protocol than is said second radio.

16. The method of claim 14 wherein said first radio is compliant with IEEE 802.11 and said second radio is compliant with Bluetooth.

17. The method of claim 14 wherein said quality of said first signal and the quality of said second signal is considered best for IEEE 802.11 operation based on IEEE 802.11 receive diversity antenna control.
